(19) United States
(12) Patent Application Publication
(10) Pub. No.: US 2026/0229637 A1
(43) Pub. Date: Aug. 6, 2026

(54) MODULAR THERMAL COMPONENT BATTERY PACK ARCHITECTURE

(71) Applicant: Rivian IP Holdings, LLC, Irvine, CA (US)

(72) Inventors: Jonathan VERGHESE, Costa Mesa, CA (US); Daniel Kurt MEHR, Irvine, CA (US); Youngbin LIM, Irvine, CA (US); Sunoj Cherian GEORGE, Irvine, CA (US); Deepak PITROLA, Irvine, CA (US); Jeffrey Michael ALVES, Pleasanton, CA (US); Casey Taylor DUNN, Mission Viejo, CA (US)

(21) Appl. No.: 19/352,452

(22) Filed: Oct. 7, 2025

Related U.S. Application Data
(60) Provisional application No. 63/752,263, filed on Jan. 31, 2025.

(51) Int. Cl. H01M 10/6556; H01M 10/613; H01M 10/615; H01M 10/625; H01M 10/63; H01M 10/6563; H01M 10/6568; H01M 10/6569

(52) U.S. Cl. CPC H01M 10/6556; H01M 10/613; H01M 10/615; H01M 10/625; H01M 10/63; H01M 10/6563; H01M 10/6568; H01M 10/6569; H01M 2220/20

(57) ABSTRACT

Embodiments of the subject technology describe a modular thermal management system for battery packs with a bottom thermal component that seals the energy volume and provides structural support, and a top thermal component as a floating structure. A first support layer connects the bottom thermal component to the base plate, while a second support layer isolates the battery subassemblies from a top lid. The system offers flexibility with single or dual thermal component configurations, optimizing for performance or cost. The dual thermal component configuration improves charging times and thermal management for demanding applications, such as steep-gradient operations in high ambient temperatures, facilitating performance stability. The single thermal component option reduces cost for less demanding scenarios. Features like turbulent flow or dimples enhance cooling, while integration of a secondary cooling loop using different refrigerants increases capacity without significantly raising costs. The modular architecture simplifies manufacturing through shared tooling and efficient assembly.

### CROSS-REFERENCE TO RELATED APPLICATIONS

The present application claims the benefit of U.S. Provisional Application No. 63/752,263, entitled “MODULAR COLD PLATE BATTERY PACK ARCHITECTURE”, filed Jan. 31, 2025, the entirety of which is incorporated herein for reference.

### INTRODUCTION

Batteries are often used as a source of power, including as a source of power for electric vehicles that include wheels that are driven by an electric motor that receives power from a battery. Aspects of the subject technology can help to improve the efficiency and/or range of electric vehicles, which can help to mitigate climate change by reducing greenhouse gas emissions.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery subassemblies that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3A illustrates a block diagram of an exploded view of a dual thermal component configuration in accordance with one or more implementations.

FIG. 3B illustrates a block diagram of a side view of the dual thermal component configuration of FIG. 3A in accordance with one or more implementations.

FIG. 4A illustrates a block diagram of an exploded view of a single thermal component configuration in accordance with one or more implementations.

FIG. 4B illustrates a block diagram of a side view of the single thermal component configuration of FIG. 4A in accordance with one or more implementations.

FIG. 5A illustrates an exploded view of a battery subassembly with integrated thermal components in accordance with one or more implementations.

FIG. 5B illustrates an example of fluid distribution channel configurations of a top thermal component and a bottom thermal component in accordance with one or more implementations.

FIG. 6A illustrates a top view of an example thermal component having a single channel configuration in accordance with one or more implementations.

FIG. 6B illustrates a top view of an example thermal component having a multi-path flow configuration in accordance with one or more implementations.

FIG. 7 illustrates a block diagram of a side view of the dual thermal component configuration with thermal isolation in accordance with one or more implementations.

FIG. 8A illustrates a perspective view of a battery pack having multiple modular bottom thermal components in accordance with one or more implementations.

FIG. 8B illustrates a side view of the battery pack that corresponds to axis B-B′ of FIG. 8B in accordance with one or more implementations.

FIG. 9 is a flow chart of illustrative operations that may be performed for thermal regulation of batteries using a single thermal component configuration in accordance with one or more implementations.

FIG. 10 is a flow chart of illustrative operations that may be performed for thermal regulation of batteries using a dual thermal component configuration in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. Structures and components are shown in block diagram form in order to avoid obscuring the concepts of the subject technology.

Mitigating battery cell derating caused by temperature constraints often serves as a limiting factor in sustaining elevated speeds of direct current fast charging (DCFC). In one or more implementations, the thermal management system is configured to extract heat from the system efficiently while prioritizing cost reduction. Achieving an equilibrium between performance retention and cost optimization across the vehicle platform can potentially result in trade-offs that impact product design and effectiveness.

Embodiments of the subject technology provide for a modular thermal management system that incorporates either one or two thermal components for battery packs, improving cooling efficiency and thermal management capabilities. The subject technology can provide improved DCFC times and enhance thermal management, specifically for high-performance applications and demanding duty cycles. For example, the dual thermal component configuration can address DCFC performance and accommodate high-performance, thermally demanding duty cycles typical of vehicle use cases, including scenarios such as steep-gradient operations under elevated ambient temperatures. Enhanced battery cooling under such conditions facilitates performance stability during varying duty cycles encountered by vehicles.

In one or more implementations, a thermal component may include or be formed as a thermal management component to regulate thermal properties of surrounding or adjacent components by providing a thermal management function to such components. A thermal management function can refer to an operational capability of a thermal component to control heat transfer by removing, distributing, or supplying thermal energy to maintain adjacent components within a defined temperature range. In one or more implementations, the thermal component may include or be formed as a thermal plate to provide thermal management functions such as cooling or heating to adjacent components such as a battery subassembly. The thermal plate may be a monolithic structure or a modular structure. In one or more other implementations, the thermal component may include or be formed as one or more tubes configured to carry a fluid to provide thermal management functions such as cooling or heating to nearby components.

The selection between a single thermal component configuration or dual thermal component configuration can depend on whether optimization is prioritized for performance or cost. In one or more implementations, the modular thermal management system can utilize a combination of a bottom thermal component, which seals off the energy volume and provides structural support, and a top thermal component, which can be designed as a floating element not tied to the back structure of the energy system. A dual thermal component configuration can be beneficial for applications where faster DCFC times are prioritized, while a single thermal component configuration can help reduce cost in low-variant solutions where high performance is not critical. This approach facilitates a battery pack thermal platform capable of meeting varying vehicle platform requirements without compromising overall operational efficiency.

The thermal components may also incorporate features such as turbulent flow or dimples to enhance cooling performance. Additionally, the modular thermal management system can integrate with a secondary thermal loop that uses a distinct fluid, such as a propane-based or refrigerant-based system, providing increased thermal function (e.g., cooling or heating) capacity while maintaining cost efficiency. The flexibility to select or combine thermal components based on specific performance needs, along with the ability to manage multiple thermal loops, allows for a more adaptable and cost-effective thermal management solution for complex thermal environments.

The subject technology also provides for enhancements in manufacturing process efficiencies, and the integration of the thermal management system with high-voltage distribution networks and electronic control modules. For example, the modular thermal management system allows for flexibility in manufacturing, enabling the thermal components to be produced with shared tooling, simplifying the overall assembly process.

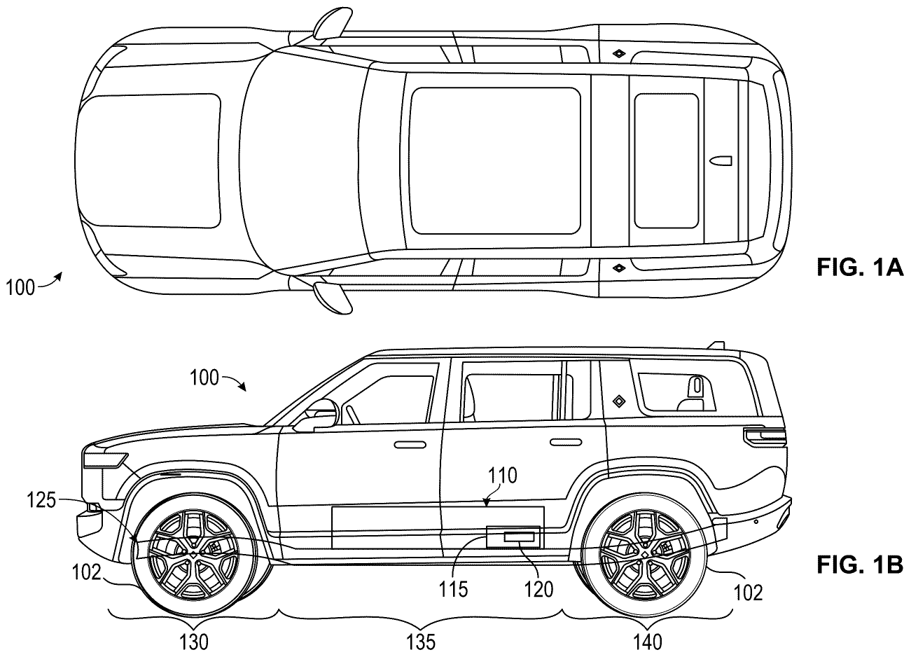

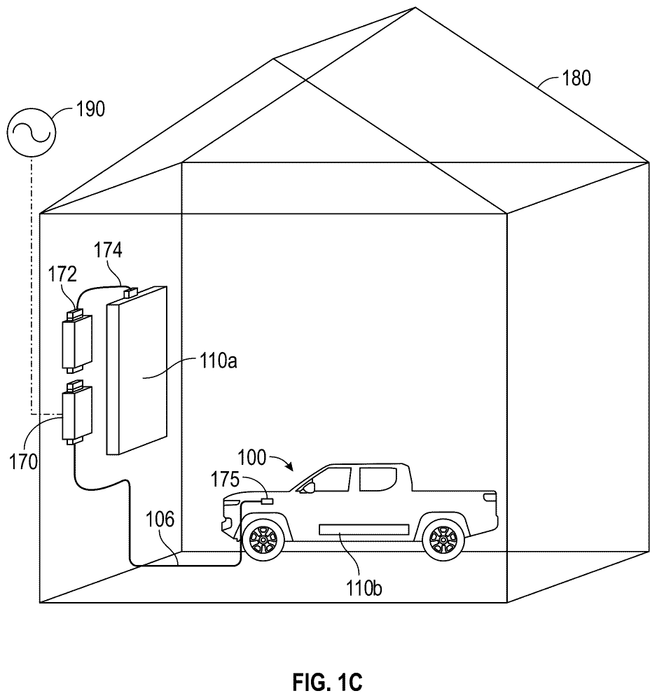

FIG. 1A is a diagram illustrating an example implementation of an apparatus as described herein. In the example of FIG. 1A, the apparatus is a moveable apparatus implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a sport utility vehicle (SUV) (e.g., an electric sport utility vehicle) having a battery pack 110. As shown, the battery pack 110 may include one or more battery subassemblies 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery subassemblies 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery subassemblies or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery subassembly, a battery module and/or a battery pack to power components of the vehicle 100. For example, a battery cell housing of the battery cells 120 can be disposed in the battery subassembly 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery subassembly 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into alternating current (AC) power for one or more components and/or systems of the vehicle (e.g., including one or more power outlets of the vehicle). The power stage circuit can be provided as part of the battery pack 110 or separately from the battery pack 110 within the vehicle 100.

As shown in FIG. 1B, vehicle 100 may include a support structure such as a chassis 125 (e.g., a frame, internal frame, or other support structure). The chassis 125 may support various components of the vehicle 100. As shown, the chassis 125 may span a front portion 130 (e.g., a hood or bonnet portion), center body portion 135, and a rear portion 140 (e.g., a trunk, payload, or boot portion) of the vehicle 100 in some implementations. In one or more implementations, battery pack 110 may be installed on the chassis 125 (e.g., within one or more of the front portions 130, center body portion 135, or the rear portion 140). In one or more other implementations, battery pack 110 may include or be electrically coupled with one or more one busbars (e.g., one or more current collector elements), of which may include electrically conductive material to connect or otherwise electrically couple battery module(s) 115 or the battery cell(s) 120 with other electrical components of vehicle 100 to provide electrical power to various systems or components of vehicle 100.

In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as an electric truck, another type of electric SUV, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery subassemblies 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 175 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110 a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

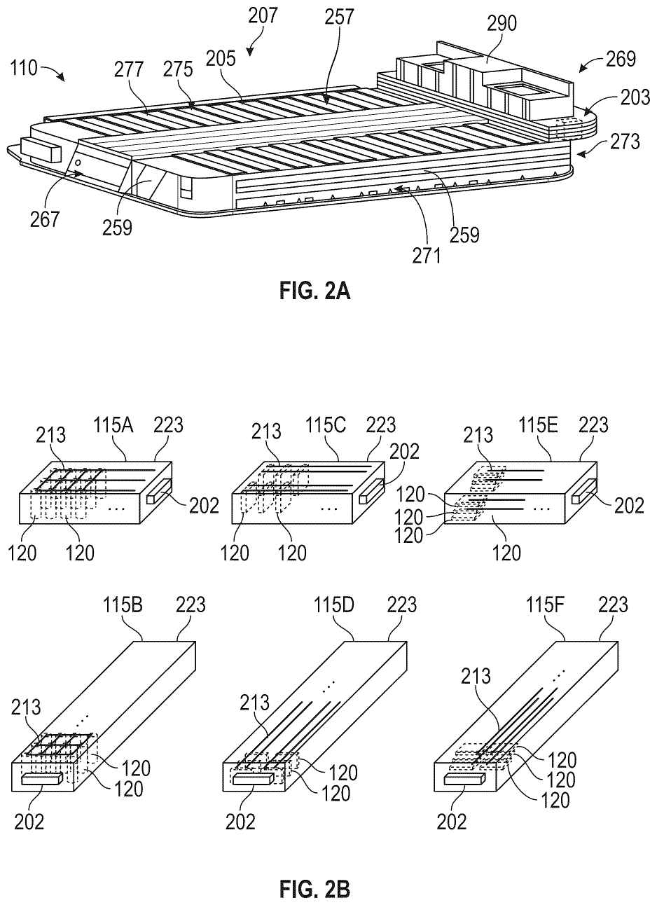

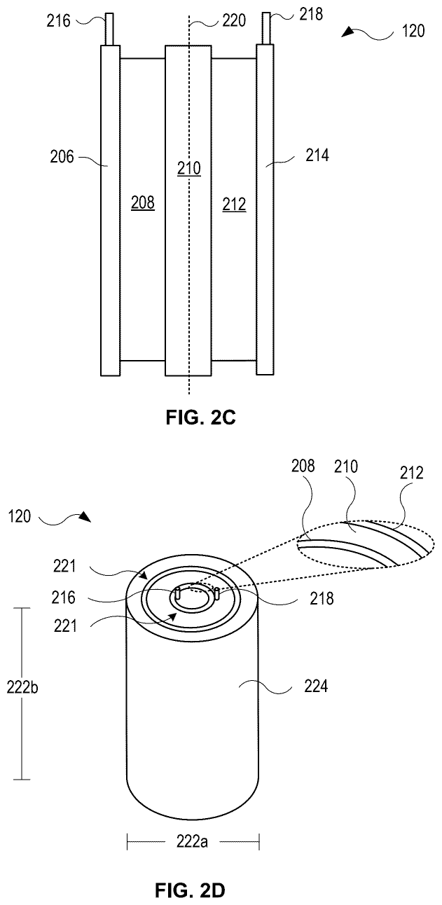

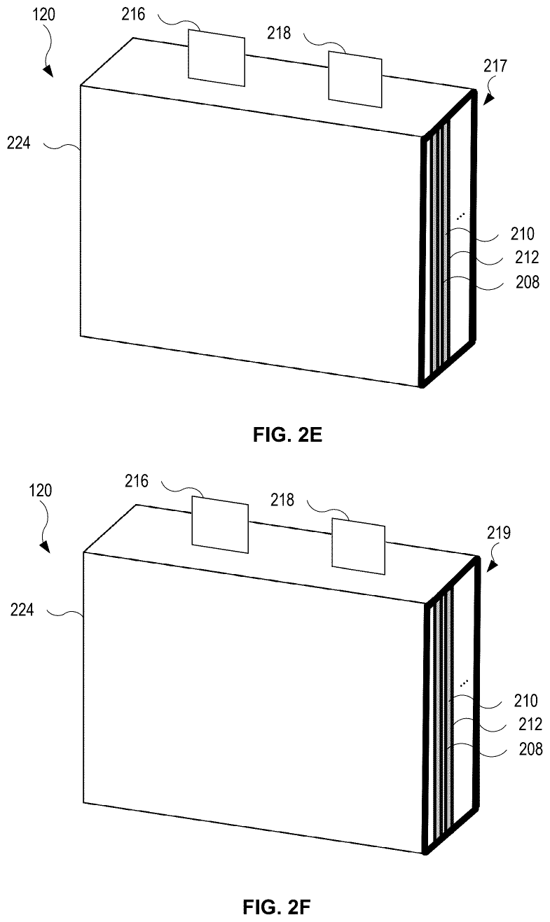

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery subassemblies 115 and/or one or more battery cells 120, and/or other battery pack components. In one or more implementations, the energy volume enclosure 205 may include or form a shielding structure on an outer surface thereof (e.g., a bottom thereof and/or underneath one or more battery subassembly 115, battery units, batteries, and/or battery cells 120) to protect the battery subassembly 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.). In one or more other implementations, the battery subassembly 115 may include or be formed as a battery module.

Battery pack 110 may include, within the energy volume 207 and the energy volume enclosure 205, multiple battery cells 120 (e.g., directly installed within the battery pack 110, or within batteries, battery units, battery modules, and/or battery subassemblies 115 as described herein) and/or battery subassemblies 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery subassemblies 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more other implementations, the modular electrical component assembly 290 may be arranged on the same plane (or in-plane) with the energy volume enclosure 205 such that the modular electrical component assembly 290 and the energy volume enclosure 205 are positioned side-by-side with one another. In one or more implementations, the modular electrical component assembly 290 may include one or more of the conductive coupling elements for routing power from the battery cells 120 and/or battery subassemblies 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations.

In one or more implementations, the modular electrical component assembly 290 may include a high-voltage distribution box (HVDB) and/or an energy management module (EMM). In one or more other implementations, the modular electrical component assembly 290 houses the HVDB and omits the EMM such that the EMM is housed in a separate assembly mounted to or arranged in-plane with the energy volume enclosure 205. In one or more other implementations, the modular electrical component assembly 290 houses the EMM and omits the HVDB such that the HVDB is housed in a separate assembly mounted to or arranged in-plane with the energy volume enclosure 205.

In one or more implementations, the HVDB is a component in electric vehicles that manages and distributes high-voltage electrical power from the battery to various systems and components within the vehicle. It can ensure the safe and efficient distribution of power, often incorporating safety features such as fuses and relays to protect the vehicle's electrical system. The HVDB can include functionality for distributing high voltage power from the battery pack 110 to various systems within the vehicle 100, facilitating efficient power management and safety by regulating and directing electrical flow to components such as the drive unit, charging system, and auxiliary systems. The HVDB can be configured as a modular and pack-agnostic component that interfaces with battery packs of varying structural and chemical configurations. It can be independently designed and manufactured, allowing it to attach externally to the battery pack 110. The integration of the HVDB is facilitated through standardized electrical and thermal connectors that are positioned at consistent locations across different battery pack designs. This uniformity supports the coupling of the HVDB with various battery packs, streamlining manufacturing processes, inventory management, and service operations.

In one or more other implementations, the EMM is a system or device that can optimize the use and distribution of energy within electric vehicle. It can monitor energy consumption, manage power distribution, and ensure efficient operation by controlling various components to reduce energy waste and improve overall performance. The EMM can be configured to optimize the use and distribution of energy within the vehicle 100 by managing energy flow between the battery pack 110, drive unit, and other electrical systems, ensuring efficient energy usage and enhancing overall vehicle performance. The EMM also can be configured to manage energy demands, improving battery life, and supporting vehicle functionalities like regenerative braking and power management during different driving conditions. In one or more other implementations, the EMM can interface with the battery pack 110 through standardized connectors, enabling it to function across different battery pack designs. The EMM can be similarly configured as a universal component compatible with various battery pack configurations. The EMM may be responsible for monitoring and controlling operational parameters of the battery pack 110. The EMM may be a collection of electronic, power, magnetic, and/or thermal management components housed within the EMM. Example components of the EMM may include a fluid, a fluid flow path, a controller, a direct current to direct current (DC-DC) converter, an alternating current to direct current (AC-DC) converter, and a direct current to alternating current (DC-AC) converter, a printed circuit board (PCB), a connector, a relay, or the like.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery subassemblies 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery subassemblies 115 and/or battery cells 120 disposed within the energy volume enclosure 205. For example, a thermal component may be positioned in contact with one or more battery subassemblies 115, battery units, batteries, and/or battery cells 120 within the energy volume enclosure 205. In one or more implementations, the battery pack 110 may include one or multiple thermal control structures and/or other thermal components for each of several top and bottom battery subassembly pairs. As shown, the battery pack 110 may include an electrical contact 203 (e.g., a high voltage connector or port) by which an external load (e.g., the vehicle 100 or an electrical system of the building 180) may be electrically coupled to the battery subassemblies and/or battery cells in the battery pack 110.

As shown, the energy volume enclosure 205 of the battery pack 110 may include a lid 277. For example, the lid 277 may cover and extend over one or more battery subassemblies 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery subassemblies 115, battery cells 120, and/or other battery subassemblies within the energy volume enclosure 205 (e.g., within a space defined by the top 257 and the sidewalls 259 of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery subassemblies 115, battery cells 120, and/or other battery subassemblies within the energy volume enclosure 205.

FIG. 2B depicts various examples of battery subassemblies 115 that may be disposed in the battery pack 110 (e.g., within the energy volume enclosure 205 of FIG. 2A). In the example of FIG. 2B, a battery subassembly 115A is shown that includes a battery subassembly housing 223 having a rectangular cuboid shape with a length that is substantially similar to its width. In this example, the battery subassembly 115A includes multiple battery cells 120 implemented as cylindrical battery cells. In this example, the battery subassembly 115A includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery subassembly 115A may include a charge collector or busbar 202. For example, the busbar 202 may be electrically coupled to the interconnect structure 213 to collect the charge generated by the battery cells 120 to provide a high voltage output from the battery subassembly 115A.

FIG. 2B also shows a battery subassembly 115B having an elongate shape, in which the length of the battery subassembly housing 223 (e.g., extending along a direction from a front end of the battery pack 110 to a rear end of the battery pack 110 when the battery subassembly 115B is installed in the battery pack 110) is substantially greater than a width (e.g., in a transverse direction to the direction from the front end of the battery pack 110 to the rear end of the battery pack 110 when the battery subassembly 115B is installed in the battery pack 110) of the battery subassembly housing 223. For example, one or more battery subassemblies 115B may span the entire front-to-back length of a battery pack within the energy volume enclosure 205. As shown, the battery subassembly 115B may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115B.

In the implementations of battery subassembly 115A and battery subassembly 115B, the battery cells 120 are implemented as cylindrical battery cells. However, in other implementations, a battery subassembly may include battery cells having other form factors, such as a battery cells having a right prismatic outer shape (e.g., a prismatic cell), or a pouch cell implementation of a battery cell. As an example, FIG. 2B also shows a battery subassembly 115C having a battery subassembly housing 223 having a rectangular cuboid shape with a length that is substantially similar to its width and including multiple battery cells 120 implemented as prismatic battery cells. In this example, the battery subassembly 115C includes rows and columns of prismatic battery cells that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery subassembly 115C may include a charge collector or busbar 202. For example, the busbar 202 may be electrically coupled to the interconnect structure 213 to collect the charge generated by the battery cells 120 to provide a high voltage output from the battery subassembly 115C.

FIG. 2B also shows a battery subassembly 115D including prismatic battery cells and having an elongate shape, in which the length of the battery subassembly housing 223 (e.g., extending along a direction from a front end of the battery pack 110 to a rear end of the battery pack 110 when the battery subassembly 115D is installed in the battery pack 110) is substantially greater than a width (e.g., in a transverse direction to the direction from the front end of the battery pack 110 to the rear end of the battery pack 110 when the battery subassembly 115D is installed in the battery pack 110) of the battery subassembly housing 223. For example, one or more battery subassemblies 115D having prismatic battery cells may span the entire front-to-back length of a battery pack within the energy volume enclosure 205. As shown, the battery subassembly 115D may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115D.

As another example, FIG. 2B also shows a battery subassembly 115E having a battery subassembly housing 223 having a rectangular cuboid shape with a length that is substantially similar to its width and including multiple battery cells 120 implemented as pouch battery cells. In this example, the battery subassembly 115C includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery subassembly 115E may include a charge collector or busbar 202. For example, the busbar 202 may be electrically coupled to the interconnect structure 213 to collect the charge generated by the battery cells 120 to provide a high voltage output from the battery subassembly 115E.

FIG. 2B also shows a battery subassembly 115F including pouch battery cells and having an elongate shape in which the length of the battery subassembly housing 223 (e.g., extending along a direction from a front end of the battery pack 110 to a rear end of the battery pack 110 when the battery subassembly 115E is installed in the battery pack 110) is substantially greater than a width (e.g., in a transverse direction to the direction from the front end of the battery pack 110 to the rear end of the battery pack 110 when the battery subassembly 115E is installed in the battery pack 110) of the battery subassembly housing 223. For example, one or more battery subassemblies 115E having pouch battery cells may span the entire front-to-back length of a battery pack within the energy volume enclosure 205. As shown, the battery subassembly 115E may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115E.

In various implementations, a battery pack 110 may be provided with one or more of any of the battery subassemblies 115A, 115B, 115C, 115D, 115E, and 115F. In one or more other implementations, a battery pack 110 may be provided without battery subassemblies 115 (e.g., in a cell-to-pack implementation). In one or more implementations, a battery pack 110 may be provided with three elongated battery subassemblies (e.g., three of battery subassemblies 115B, 115D, and/or 115F).

In one or more implementations, multiple battery subassemblies 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery subassemblies 115. For example, the battery pack 110 may have a cell-to-pack configuration in which battery cells 120 are arranged directly into the battery pack 110 without assembly into a battery subassembly 115 (e.g., without including a separate battery subassembly housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium-ion battery cell in which the anode 208 is formed from a carbonaceous material (e.g., graphite or silicon-carbon). In these implementations, lithium-ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium-ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212 and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, the battery cell 120 can include an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a busbar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery subassembly or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

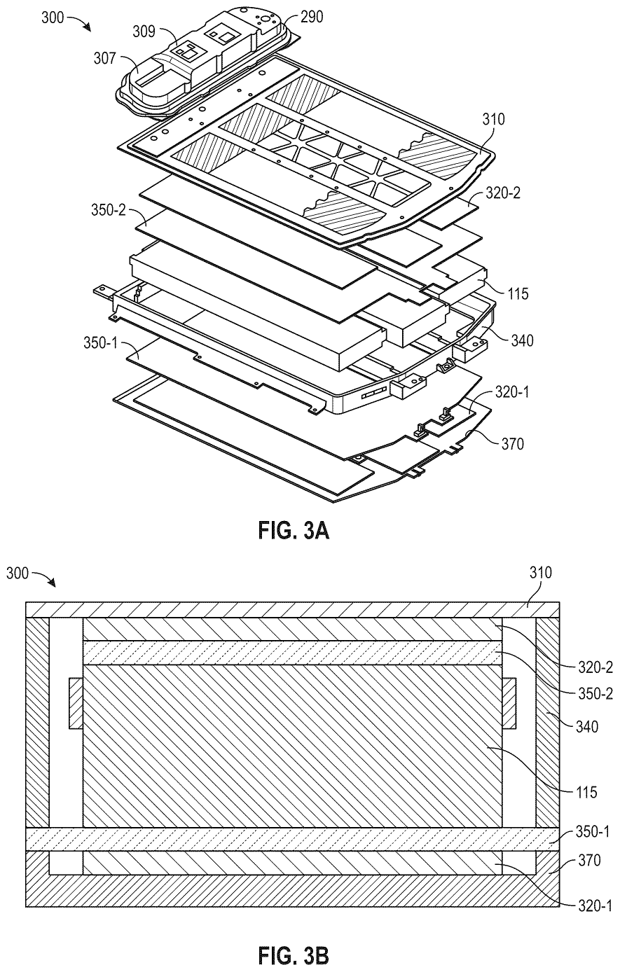

FIG. 3A illustrates a block diagram of an exploded view of a thermal system architecture 300 in accordance with one or more implementations. FIG. 3B illustrates a block diagram of a side view of the thermal system architecture 300 of FIG. 3A in accordance with one or more implementations. In one or more implementations, the thermal system architecture 300 may include two different arrangements. Both arrangements may incorporate dual-sided thermal regulation to increase the total surface area of battery cell contact, improving the rate of heat removal from the battery pack 110. For example, a first arrangement may utilize a modular thermal component configuration in which each battery subassembly 115 can incorporate a dedicated top thermal component or bottom thermal component, while a second arrangement may employ a larger thermal component configured for battery pack level thermal management, or a combination thereof. Modularity may allow omission of one thermal component in lower-performance applications.

As illustrated in FIGS. 3A and 3B, the thermal system architecture 300 includes components such as a support structure 340, a first thermal component 350-1, battery subassemblies 115 containing battery cells 120, a first support layer 320-2 positioned between the first thermal component 350-1 and the base plate 370, and a second support layer 320-1 located between a lid 310 and a second thermal component 350-2. The second thermal component 350-2 may interact with busbars positioned in the stack. These busbars can be mounted above the second thermal component 350-2 to enable active thermal management in configurations that include both first and second thermal components 350-1, 350-2. In one or more implementations, one or more of the first thermal component 350-1 or the second thermal component 350-2 may be configured as a single component capable of providing thermal management functions (e.g., cooling or heating) to multiple battery subassemblies 115 simultaneously and may also integrate additional functions such as sealing and mechanical closure of the lid 310. In one or more other implementations, the thermal system architecture 300 may employ a large second thermal component 350-2 and multiple first thermal component 350-1 components spanning multiple battery subassemblies 115, potentially integrating additional functions such as a top lid and thermal management surfaces into a single assembly to simplify manufacturing and installation. In one or more other implementations, the thermal system architecture 300 may utilize multiple smaller, module-level thermal components as both the second thermal component 350-2 and first thermal component 350-1, supporting modular installation and potentially differing maintenance procedures.

In one or more other implementations, the thermal system architecture 300 may be configured to vary the number of thermal components employed depending on the cost and performance parameters of a target vehicle platform. For example, the thermal system architecture 300 may omit one of the first thermal component 350-1 or the second thermal component 350-2. For vehicle platforms positioned in lower cost categories, a single thermal component may be utilized to reduce component cost and to reduce the overall capacity of the thermal system architecture 300. In such configurations, thermal attributes such as charging duration and other thermally constrained operating cases may exhibit reduced performance metrics, which aligns with the design tradeoffs associated with lower cost vehicles. For vehicle platforms positioned in higher cost categories, two or more thermal components may be employed to increase thermal system capacity and to provide improved thermal attributes, including reduced charging duration and improved management of thermally limited operating cases. In this manner, the thermal system architecture 300 can provide flexibility to support a range of vehicle price points by selectively including or excluding a second thermal component independent of substantial redesign of the overall assembly.

In one or more other implementations, the modular electrical component assembly 290 may incorporate functionality for integrating the thermal system architecture 300 used for battery cells 120 with other electronic components of the battery pack 110. Specifically, the second thermal component 350-2, which provides thermal regulation for the battery cells 120, can be thermally coupled to the modular electrical component assembly 290. For example, the second thermal component 350-2 may provide a thermal management function to a side of the modular electrical component assembly 290. This configuration allows for a unified thermal management system that facilitates heat transfer between the battery cells 120 and electronic systems within the modular electrical component assembly 290.

In one or more other implementations, the modular electrical component assembly 290 may be integrated with the first thermal component 350-1 and the second thermal component 350-2 to facilitate that electronic components within the modular electrical component assembly 290 are maintained within optimal thermal conditions. For example, the second thermal component 350-2 may provide a thermal management function to a side of the modular electrical component assembly 290. By integrating the thermal system architecture 300 across the battery cells 120 and the modular electrical component assembly 290, the battery pack 110 can achieve a streamlined design that simplifies the design and maintenance of battery systems in applications such as electric vehicles. For example, the second thermal component 350-2 can be thermally coupled to the battery subassemblies 115 and the modular electrical component assembly 290 to provide a thermal management function to each of the battery subassemblies 115 and the modular electrical component assembly 290.

The support structure 340 can also be integrated into the thermal system architecture 300 to provide mechanical stability. Integrating the first thermal component 350-1 into the support structure 340 can simplify manufacturing by reducing the complexity of the enclosure design. From a manufacturing perspective, the structure and thickness of the first and second thermal components 350-1, 350-2 can be optimized to balance thermal management performance and structural integrity. Thermal function volumes for the first thermal component 350-1 and the second thermal component 350-2 can either be consistent or vary based on operational conditions.

In one or more implementations, the second thermal component 350-2 can be integrated with the lid 310 to form a unified structure. The lid 310 can be made from stamped steel. Integrating the lid 310 with the second thermal component 350-2 adds reinforcement, resulting in a more robust structure. This integrated configuration can exceed the structural integrity of a standalone lid. For example, cylindrical cell systems may rely on the lid 310 alone for support, whereas the inclusion of the second thermal component 350-2 as a load-bearing element can improve durability, vibration resistance, and shock absorption.

The size and configuration of the first thermal component 350-1 and the second thermal component 350-2 may be adjusted based on specific requirements of the thermal system architecture 300. In one or more implementations, as illustrated in FIG. 3B, the first thermal component 350-1, integrated into the support structure 340, may have a larger volume to support its role in providing structural support. The larger size of the first thermal component 350-1 allows it to effectively seal the energy volume. In the event of a bottom impact, a rupture in the first thermal component 350-1 directs fluid leakage downward and out of the vehicle 100, reducing the risk of fluid intrusion into the energy volume. In In one or more other implementations, the second thermal component 350-2 may not seal the fluid or energy volume, offering more flexibility in its configuration.

In one or more other implementations, the first thermal component 350-1 can be combined with the base plate 370 into a single assembly. These configurations reduce manufacturing complexity, enhance structural rigidity, and improve assembly efficiency. The second thermal component 350-2 may serve as a floating thermal component, unattached to the support structure 340, and is instead mounted to the top of the battery cells 120.

Various cell chemistries and formats, including prismatic cells with hard cases or soft pouches, can be supported by the thermal system architecture 300. Chemistries such as lithium iron phosphate (LFP) and nickel cobalt manganese (NCM) can be made compatible with the thermal system architecture 300. Features such as side terminal and side vent locations also can be accommodated, allowing for both top and bottom thermal management configurations. For cells with alternative vent placements, such as top or bottom vents, the thermal components (e.g., 350-1, 350-2) can be modified to include vent manifold features for gas management and routing to pressure relief valves (PRVs) or external components.

The dimensions and structure of the support layers, such as the first support layer 320-2 and the second support layer 320-1, can be determined by the size and arrangement of the first and second thermal components 350-1 and 350-2, respectively. The first and second support layers 320-2, 320-1 can meet specific load cases within different sections of the battery pack 110 by providing structural reinforcement in areas such as the footwell or thermal isolation in regions with less stringent structural demands. In configurations where both the first thermal component 350-1 and the second thermal component 350-2 are present, the second support layer 320-1 layer can be adjusted to meet the specific structural and thermal requirements introduced by the second thermal component 350-2.

The first thermal component 350-1, positioned at the bottom of the battery pack 110, can be configured to withstand ground strikes and bottom impact loads. This configuration protects the battery cells 120 and maintains the structural integrity of the battery pack 110 by balancing mechanical strength with thermal isolation. Similarly, the second thermal component 350-2, located on the top side of the battery pack 110, can be configured to handle impact forces from above, such as dropped objects or collisions, as it may be integrated with the vehicle 100 floor. To address potential corrosion in the thermal component material due to environmental exposure, intermediate layers between the second support layer 320-1 and the second thermal component 350-2 can be reduced, facilitating direct contact between the second support layer 320-1 and the second thermal component 350-2. In this regard, the integrated structure of the second thermal component 350-2 can be configured to effectively absorb impact loads. Manufacturing efficiency can be improved by employing an inverted tub configuration, which simplifies assembly processes and optimizes the integration of the second thermal component 350-2. Integrating impact-resistance features directly into the second thermal component 350-2 can reduce the need for additional support layers (e.g., 320-1), simplifying the thermal system architecture 300.

In implementations where both thermal components (e.g., 350-1 and 350-2) are utilized, the thermal system architecture 300 can be configured to extend across the entire battery pack 110, offering improved integration and performance compared to setups with individual modular components. From an assembly perspective, the thermal system architecture 300 may utilize large-format thermal components, such as the first thermal component 350-1 and the second thermal component 350-2, to reduce the number of components, simplifying the assembly process and improving integration efficiency. These improvements are particularly advantageous for battery cells 120 using prismatic cells, where the reduced component count simplifies workflows and enhances manufacturability. The decreased component count and reduced assembly complexity can contribute to cost savings. In one or more implementations, large-format thermal components, such as the first thermal component 350-1 and the second thermal component 350-2, can be utilized, featuring a single inlet port and outlet port located at the front of the battery pack 110. This arrangement can reduce the need for internal fluid manifolds that would otherwise be used to connect multiple smaller thermal components. The placement of inlets and outlets outside the battery subassemblies 115 can reduce the risk of fluid leaks near high-voltage components, improving safety and reliability. In one or more other implementations, the integration of the second thermal component 350-2 provides for high-leak-risk interfaces to be positioned externally to the battery subassemblies 115, further enhancing the overall reliability of the thermal system architecture 300.

The integration of large-format thermal components, such as the first thermal component 350-1 and the second thermal component 350-2, into the battery pack 110 can simplify manufacturing and increase flexibility by allowing both components to be produced using similar stamping or machining methods. This configuration can reduce the number of connections required and reduce the need for specialized features specific to either top-only or bottom-only configurations, facilitating a unified manufacturing strategy and reducing production complexity. For configurations using a three-bay layout, commonly employed in modular systems with multiple battery subassemblies 115, the dual thermal component arrangement can improve structural compliance across the three bays during assembly. This structural compliance can preserve the alignment of the cell stack and reduce the need for additional support components, such as separate enclosures. Compared to cylindrical cell systems, the three-bay configuration with the first and second thermal components 350-1, 350-2 within the thermal system architecture 300 can provide improved stiffness and greater flexibility in packaging. Removing internal divisional features within the cell stack can simplify assembly and reduce complexity of the thermal system architecture 300 while maintaining the structural stability of the battery pack 110.

The inlet and outlet arrangement of the thermal system architecture 300 can operate either dependently or independently. Separate inlets and outlets may be assigned to the first thermal component 350-1 and the second thermal component 350-2, or a shared inlet and outlet may be used for both. In one or more implementations, the thermal system architecture 300 can incorporate a valve system to deactivate one of the thermal components, such as the second thermal component 350-2, while allowing the other to remain active.

The thermal system architecture 300 can provide redundancy by enabling continued operation in a reduced thermal management mode if the first thermal component 350-1 or the second thermal component 350-2 encounters a fault, clogging, or derating. This redundancy configuration can support functional safety by ensuring that the battery pack 110 can continue performing over a specified drive cycle even when one of the thermal components is non-operational, improving the reliability and adaptability of the thermal system architecture 300.

In one or more implementations, the thermal system architecture 300 allows for the independent and dynamic activation of the first thermal component 350-1 and the second thermal component 350-2 through software or hardware upgrades, providing operational flexibility to meet varying thermal demands. For example, during typical conditions such as urban driving or motorway use with lower thermal loads, the first thermal component 350-1 may be dynamically activated. Conversely, high-performance scenarios, such as motorsport applications, uphill driving, or operation in regions with high ambient temperatures may benefit from the activation of both thermal components (e.g., 350-1, 350-2) to handle increased thermal loads. The thermal system architecture 300 also addresses thermal challenges during demanding charging scenarios, such as sustained exposure to elevated ambient temperatures followed by fast charging. In such cases, activating the second thermal component 350-2 provides additional thermal function capacity, facilitating effective thermal management and maintaining battery performance during rapid temperature changes.

In some implementations, a valve or control mechanism can be incorporated into the thermal system architecture 300 to enable selective activation of the first thermal component 350-1, the second thermal component 350-2, or both. This capability allows the thermal management performance to be adjusted based on specific operational needs.

Furthermore, different fluid types can be employed when the first thermal component 350-1 and the second thermal component 350-2 are connected to separate thermal regulating circuits. In one or more implementations, the thermal system architecture 300 may include a secondary loop that utilizes a separate fluid, such as a propane-based refrigerant or other alternatives. The use of differing fluids can offer distinct advantages based on their thermal and fluid properties. For example, one fluid with a higher heat capacity can effectively absorb and transport larger quantities of heat, making it suitable for managing high thermal loads, such as those generated by a propulsion system. Conversely, a fluid with lower viscosity may exhibit reduced pumping losses, facilitating efficient operation in the thermal system architecture 300 benefiting from higher flow rates, such as those supporting cabin temperature regulation.

This dual-loop configuration can improve the thermal management performance and operational flexibility of the thermal system architecture 300 by distributing thermal loads across two thermal management loops. The secondary loop can be integrated into the thermal system architecture 300 to enhance thermal function (e.g., cooling or heating) capacity without significantly increasing costs. In this configuration, the first thermal component 350-1 and the second thermal component 350-2 may be shared between the primary and secondary loops, where one thermal management loop is tasked with managing thermal loads from the propulsion system, while the other thermal management loop can support the cabin temperature regulation parameters of the vehicle 100. The dual-loop system can also be supported by valves and/or control mechanisms to regulate the fluid flow and facilitate optimal thermal performance under varying operational conditions.

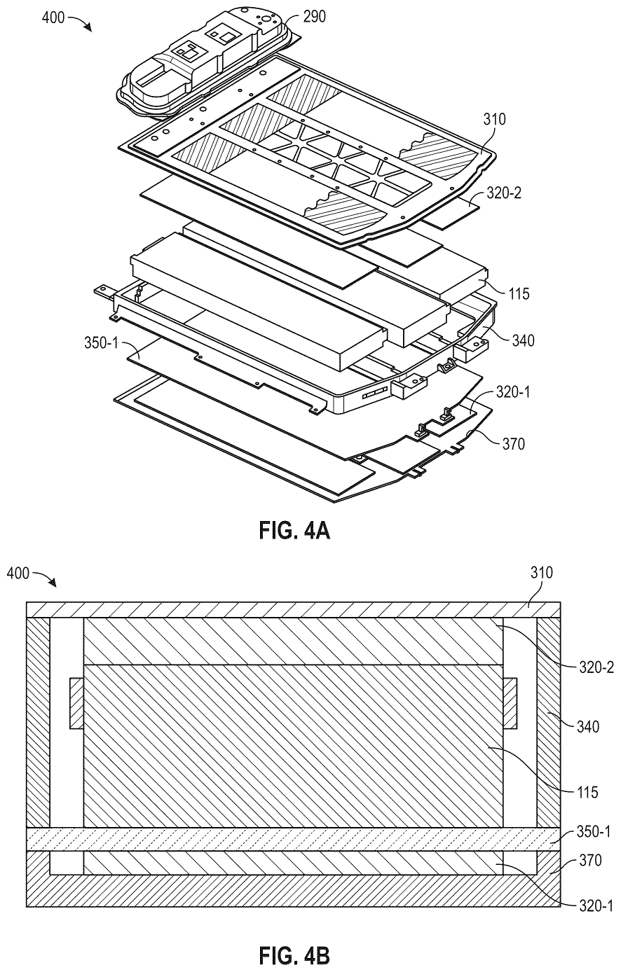

In one or more implementations, embodiments of the subject technology include the first thermal component 350-1, the second thermal component 350-2, or a combination of both. For example, the subject technology enables the integration of the first thermal component 350-1 and the second thermal component 350-2 for high-performance applications, such as fast-charging systems for the vehicle 100, to achieve effective thermal management. For applications involving slower charging rates, the subject technology allows the second thermal component 350-2 to be omitted, resulting in a simplified and cost-efficient configuration. FIG. 4A illustrates a block diagram of an exploded view of a single thermal component configuration in accordance with one or more implementations. FIG. 4B illustrates a block diagram of a side view of the single thermal component configuration of FIG. 4A in accordance with one or more implementations. As illustrated in FIGS. 4A and 4B, a thermal system architecture 400 includes the support structure 240, the first thermal component 350-1, the battery subassemblies 115 containing battery cells 120, the first support layer 320-1 positioned between the first thermal component 350-1 and the base plate 370, and the second support layer 320-2 located beneath the lid 310.

In configurations where only the first thermal component 350-1 is present, the second support layer 320-2 layer beneath the lid 310 can be thicker to fill the additional spacing between the lid 310 and the battery cells 120. This increased thickness not only fills the gap but also compensates for the structural reinforcement that would be provided by the second thermal component 350-2. In these instances, the second support layer 220-2 can be optimized to withstand top-side impacts and vibration loads.

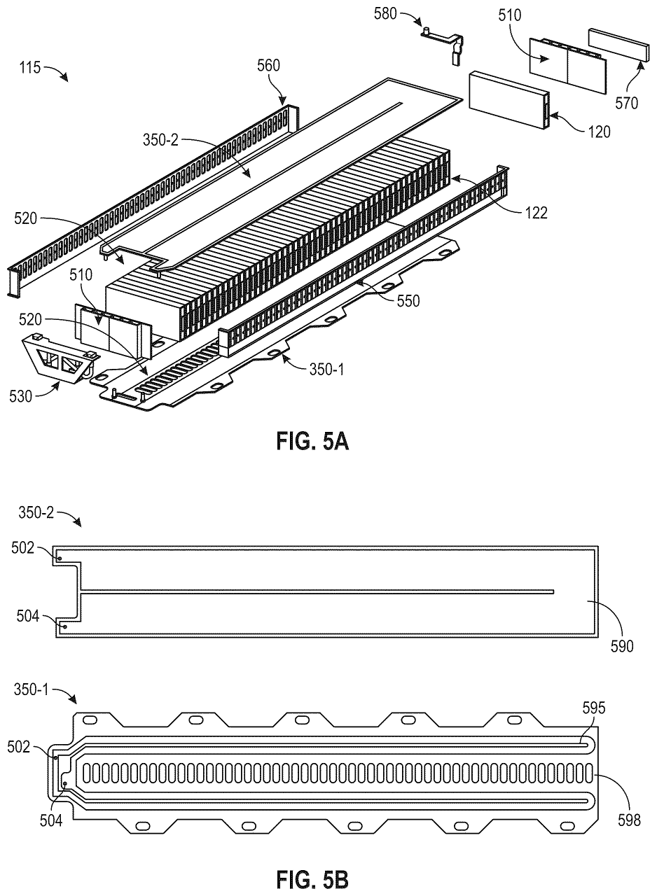

FIG. 5A illustrates an exploded view of a battery subassembly 115 with integrated thermal components in accordance with one or more implementations. Battery subassembly 115 includes a plurality of battery cells 120 arranged in a defined series and/or parallel configuration, with electrical interconnection provided by a busbar assembly 580. The busbar assembly 580 electrically couples adjacent cells, provides voltage sense points, and may include fusible links for protection. Mechanical restraint of the battery cell array 122 is provided by end plates 510, which apply compressive load to maintain cell alignment and structural stability. Thermal management can be provided by a first thermal component 350-1 and a second thermal component 350-2 positioned on opposing sides of the battery cell array 122, each thermal component can incorporate internal fluid channels connected to a module manifold assembly 530 for fluid distribution. Adhesive layers 520 can be disposed between the battery cells 120 and the thermal components 350-1 and 350-2, and between structural members, to provide bonding, thermal conduction, and mechanical damping. Electrical terminations for external connection can be consolidated on a terminal side current collector assembly (CCA) 550, which can route the module positive and negative rails from the busbar assembly 580 to serviceable terminals. A non-terminal side CCA 560 is located on the opposite side to provide structural support and routing for auxiliary connections. A battery monitoring circuit 570 is connected to voltage sense points on the busbar assembly 580 and to temperature sensors positioned on or near representative battery cells 120, with isolation features provided to separate measurement circuitry from chassis ground. The first thermal component 350-1, second thermal component 350-2, module manifold assembly 530, and end plates 510 are arranged to provide a defined thermal path from the cells to the fluid. The battery monitoring circuit 570 may be connected to both the terminal side CCA 550 and the non-terminal side CCA 560. In operation, the batter subassembly 115 conducts electrical current between external terminals through the battery cells 120 and busbar assembly 580, while heat generated by the batter cells 120 is transferred through the the thermal components 350-1 and 350-2 and removed by fluid distributed through the module manifold assembly 530, with the end plates 510 maintaining structural integrity.

In one or more implementations, configurations of the battery subassembly 115 may include a shear plate with integrated vents in lieu of the first thermal component 350-1 to maintain structural and venting functionality. When both the first thermal component 350-1 and the second thermal component 350-2 are present, the first thermal component 350-1 may also function as the shear plate, providing combined thermal and structural performance. The first thermal component 350-1 configuration may be implemented on a per-battery subassembly 115 basis, with each battery subassembly 115 incorporating its own first thermal component 350-1 assembly. The first thermal component 350-1 may also serve as a thermal insulation layer, with the integrated vents configured to manage thermal runaway events by directing ejecta and preventing particulate, gas, or debris from re-entering sensitive areas such as electrical terminals. The first thermal component 350-1 may incorporate thermal protection features to reduce the likelihood of battery cell failures. These venting protection features may be specific to the first thermal component 350-1, as vent locations may be positioned at the lower portion of the battery pack 110.

Blind-mate interfaces may be incorporated at each end plate 510 of the battery subassembly 115, allowing fluid line connections to be made vertically irrespective of precise manual positioning. In one or more implementations, a carrier structure (not shown) may be coupled to one of the first thermal component 350-1 or the second thermal component 350-2, with the opposing thermal component installed in a manner that allows inlet port (e.g., inlet 502 of FIG. 5B) and outlet port (e.g., outlet 504 of FIG. 5B) ports to blind-mate into corresponding fittings. Both fluid flow architectures may employ an out-and-back circulation channel design, resulting in the module manifold assembly 530 being located adjacent to one end plate 510 at one end of the battery subassembly 115. The opposite end may contain the battery monitoring circuit 570 and opposing end plate 510. Spring tab features may be integrated into female fittings to facilitate self-alignment during blind-mate engagement. These fittings may employ a conical lead-in geometry and spring retention elements to allow limited multi-directional movement, aiding in centering and engagement. The spring tabs may be integrated into a bracket assembly supporting the fittings.

FIG. 5B illustrates an example of fluid distribution channel configurations of a top thermal component and a bottom thermal component in accordance with one or more implementations. In one or more implementations, during assembly, one of the first thermal component 350-1 or second thermal component 350-2 can be secured to the battery cell 120 structure, while the other thermal component can be aligned and installed in a manner that may be performed as a blind-mate operation, minimizing manual positioning relative to the inlet 502 and the outlet 504. In one or more implementations, each of the thermal system architecture 300 and/or the thermal system architecture 400 may route fluid flow across the width of the vehicle 100. In one or more other implementations, each of the thermal system architecture 300 and/or the thermal system architecture 400 may route fluid flow along the length of the vehicle 100. As illustrated in FIG. 5B, the fluid is routed along the length of each of the first thermal component 350-1 and the second thermal component 350-2.

In one or more implementations, the fluid flow architecture utilizes parallel flow paths to each battery subassembly 115, with designated inlet 502 and outlet 504 ports. The second thermal component 350-2 may employ a direct out-and-back first circulation channel 590, while the first thermal component 350-1 may include a similar out-and-back second circulation channel 595 with a venting architecture 598 having vented sections positioned to avoid routing fluid through certain regions at the bottom of the battery cells 120. The circulation channel layouts between the first thermal component 350-1 and the second thermal component 350-2 may differ to optimize the thermal system architecture 300 performance and prevent undesired fluid exposure in specific areas.

In one or more implementations, the fluid may be supplied through the inlet 502 that may branch into separate parallel flow paths for the first thermal component 350-1 and the second thermal component 350-2, with each thermal component operating independently. The outlet flow may be recombined into a single return path via the outlet 504. In configurations where the second thermal component 350-2 is omitted, the branch connection may be blocked to direct fluid flow through the first thermal component 350-1. In one or more implementations, routing of the inlet 502 and outlet 504 across the battery subassemblies 115 may vary depending on the battery subassembly 115 orientation and the vehicle 100 architecture. In one or more implementations, the battery subassemblies 115 may be stacked laterally from side to side. In one or more other implementations, the battery subassemblies 115 may be stacked longitudinally along the length of the vehicle 100. As illustrated in FIGS. 3A-3B, 4A-4B, and 5A-5B, the battery subassemblies 115 are stacked longitudinally along the length of the first thermal component 350-1 and second thermal component 350-2.

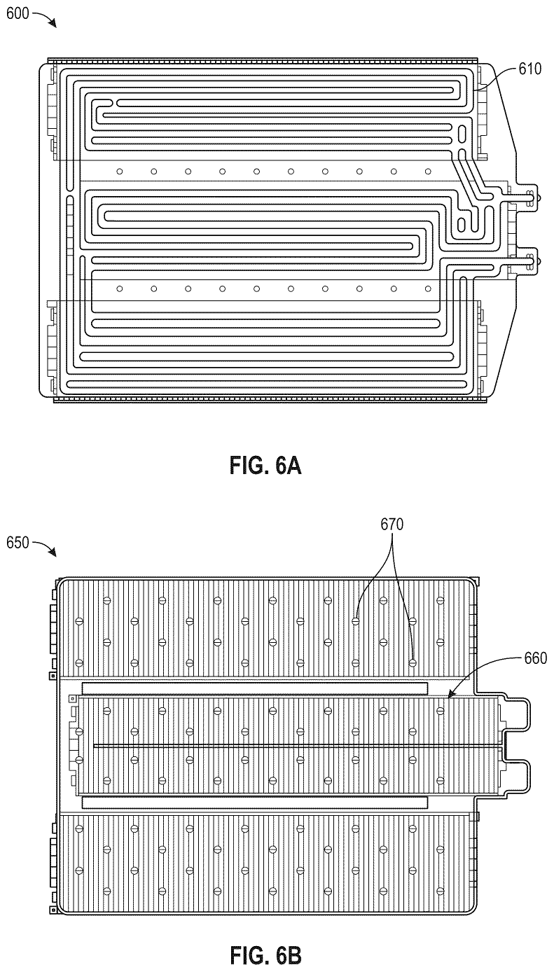

FIG. 6A illustrates a top view of an example thermal component 600 having a single channel configuration in accordance with one or more implementations. The structural performance of the first thermal component 350-1 and the second thermal component 350-2 can be further enhanced by integrating metallic elements into the assembly. These additions can improve mechanical properties, increase load-bearing capacity, and modify the modal behavior of the thermal component structure to enhance overall durability.

As illustrated in FIG. 6A, the thermal component 600 can include a single-channel configuration such as a serpentine flow channel structure 610. In one or more implementations, the single-channel configuration can be used to optimize the temperature differential across the battery cells 120 and minimize system pressure drop.

FIG. 6B illustrates a top view of an example thermal component 650 having a multi-path flow configuration in accordance with one or more implementations. As illustrated in FIG. 6B, the thermal component 650 may include a multi-path flow configuration, such as a stamped turbulator flow channel structure 660, to promote turbulent flow. The stamped turbulator flow channel structure 660 includes dimples 670, which act as turbulators to promote turbulent flow and improve thermal management efficiency. The number and placement of the dimples 670 can be optimized based on specific requirements of the thermal system architecture 300. The stamped turbulator flow channel structure 660 can serve as an alternative to the serpentine flow channel structure 610 of FIG. 6A. The multi-path flow configuration provides redundancy by allowing fluid to bypass deformed sections, maintaining sufficient thermal management performance. For example, a 16-channel configuration can be employed to manage fluid flow across the battery pack 110, offering improved thermal performance compared to simpler flow arrangements.

The choice between the serpentine flow channel structure 610 (FIG. 6A) and the stamped turbulator flow channel structure 660 may depend on performance optimization requirements. For example, fluid routing for the first thermal component 350-1 and the second thermal component 350-2 may differ to address specific thermal management needs and flow dynamics. Although the multi-path flow configuration may provide a different thermal management efficiency compared to the single-channel configuration, the multi-path flow configuration can provide greater resilience to localized deformation, making the stamped turbulator flow channel structure 660 suitable for applications where bottom impacts are a concern.

In one or more implementations, the first thermal component 350-1 may include the stamped turbulator flow channel structure 660, whereas the second thermal component 350-2 may include the serpentine flow channel structure 610. The first thermal component 350-1, incorporating the stamped turbulator flow channel structure 660, can be positioned at the bottom of the thermal system architecture 300 to achieve beneficial turbulence and flow characteristics while tolerating impacts more effectively. In one or more implementations, the second thermal component 250-2, incorporating the serpentine flow channel structure 610, can be positioned at the top of the thermal system architecture 300, where the risk of bottom impacts is minimal. In one or more other implementations, the second thermal component 350-2 may include the stamped turbulator flow channel structure 660 and the first thermal component 350-1 may include the serpentine flow channel structure 610.

In one or more other implementations, a uniform configuration may be applied to both thermal components 350-1, 350-2 if certain operational conditions are satisfied. In one example, both the first thermal component 350-1 and the second thermal component 350-2 include the serpentine flow channel structure 610 of FIG. 6A. In another example, both the first thermal component 350-1 and the second thermal component 350-2 include the stamped turbulator flow channel structure 660.

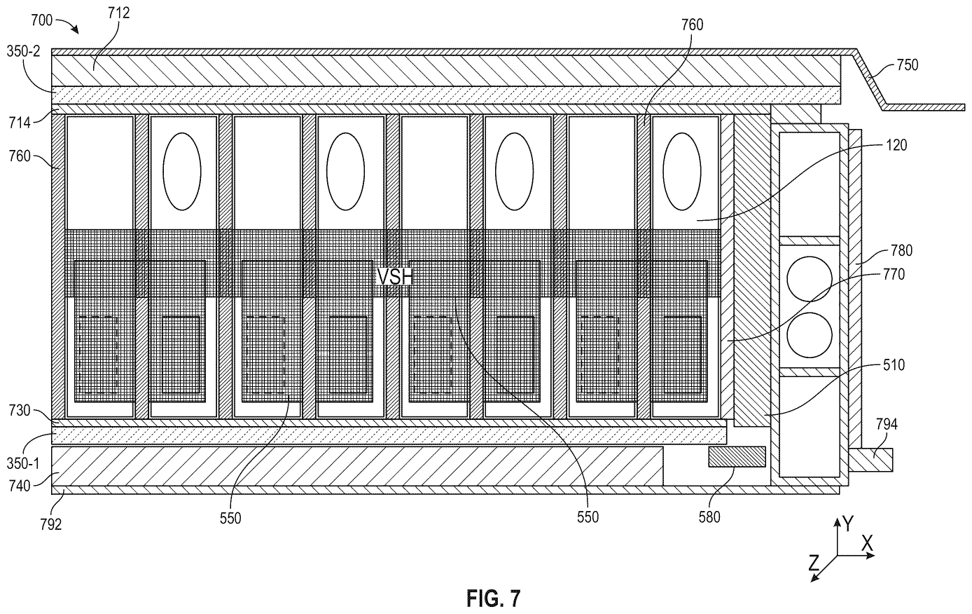

FIG. 7 illustrates a block diagram of a side view of the modular thermal component configuration 700 with thermal isolation in accordance with one or more implementations. As illustrated in FIG. 7, the modular thermal component architecture 700 includes the second thermal component 350-2 arranged on a top side of a battery cell 120 (or a battery subassembly 115). The modular thermal component architecture 700 also includes the first thermal component 350-1 arranged on a bottom side of the battery cell 120 (or the battery subassembly 115). The second thermal component 350-2 and/or the first thermal component 350-1 can be directly bonded onto the battery cell 120 (or battery subassembly 115). In one or more implementations, each of the first thermal component 350-1 and the second thermal component 350-2 includes a thermally conductive material. In one or more implementations, no metal conduction paths may be present between the battery cells 120 and a housing 794. Thermal barrier layers 760 may be interposed between the battery cells 120 along the y-direction.

In one or more implementations, the thermal isolation in the modular thermal component configuration 700 provides for the first thermal component 350-1 and/or the second thermal component 350-2 to be thermally isolated from external environments for LFP-based battery pack systems. The degree of thermal isolation provided by the first thermal component 350-1 can be influenced by factors such as the channel configuration and the thickness of the first thermal component 350-1. For off-road configurations, for example, the inclusion of a skid plate 792 can be beneficial to provide additional structural protection. In one or more implementations, the modular thermal component configuration 700 may accommodate greater cell deformation for LFP systems compared to Ternary (NCM)-based systems. In one or more implementations, the thermal isolation in the modular thermal component configuration 700 may be applicable to both NCM-and LFP-based battery packs.

The modular thermal component architecture 700 can optimize the available space by reducing the need for an additional battery pack top lid, instead reinforcing the second thermal component 350-2 by increasing its thickness. To serve as both a thermal component and structural element, the thickness of the second thermal component 350-2 may be increased. The second thermal component 350-2 functioning as a structural element to serve as a lid can reduce the need for vent channels between the battery pack 110 top lid and the battery cell 120 due to cell venting in the y-direction, as illustrated in FIG. 7.

Since the second thermal component 350-2, constructed of a rigid metal such as aluminum, can be directly bonded with the battery cells 120, the second thermal component 350-2 can exhibit increased heat dissipation at low temperatures. To mitigate this, a thermal insulation layer 712 can be disposed onto a top side of the second thermal component 350-2, enhancing isolation and reducing heat loss, thus reducing internal air gaps in the battery pack 110 and between a vehicle floor 750 and the battery pack 110. The thermal insulation layer 712 can be positioned over the entire top side of the second thermal component 350-2, effectively obstructing airflow between the second thermal component 350-2 serving as the battery pack lid and the vehicle floor 750. The thermal insulation layer 712 may function as a structural element to provide structural support for sheer loads. Heat conduction to a housing 794 can be reduced through the inclusion of an insulation pad 770 and the end plate 510. In one or more other implementations, an additional insulation pad 780 can be incorporated on the exterior of the housing 794.

The second thermal component 350-2 may include additional structural features, such as structural reinforcements or impact mitigation measures for durability against potential external loads (e.g., heavy objects dropped on the vehicle floor). The application of thermal insulation and noise, vibration, and harshness (NVH) pads provides additional structural integrity and thermal protection to the second thermal component 350-2, increasing its overall thickness (e.g., by approximately 10 mm) for enhanced robustness and rigidity.

The second thermal component 350-2 may integrate with a thermal insulation layer 714 as a unified lid. The thermal insulation layer 714 can be mechanically coupled to the second thermal component 350-2 by an adhesive material. In one or more other implementations, a thermal insulation layer 730 can be interposed between the bottom side of the battery cell 120 (or the battery subassembly 115) and the first thermal component 350-1. The thermal insulation layer 730 can be mechanically coupled to the first thermal component 350-1 by an adhesive material. In one or more implementations, an energy absorbing material 740 may be disposed onto a bottom side of the first thermal component 350-1 such that the energy absorbing material 740 provides additional structural integrity to the first thermal component 350-1.

The first thermal component 350-1 and the second thermal components 350-2 can differ in dimensions based on functional requirements. For example, the second thermal component 350-2, serving as a structural element as the battery pack 110 top lid and the vehicle floor 750, can have a greater thickness compared to the first thermal component 350-1. For example, the second thermal component 350-2 may have a thickness of about 5 mm and the first thermal component 350-1 may have a thickness of about 4 mm.

In one or more implementations, the battery pack 110 can retain a robust thermal component structure along the battery subassembly length, even when a middle section of the battery pack 110 is cut out. The modular thermal component architecture 700 may allow either of the first thermal component 350-1 or the second thermal components 350-2 to function as structural members for the battery subassembly 115, reducing the need for an additional encapsulating layer around the battery cells 120. The battery cells 120 can be directly assembled onto the first thermal component 350-1, and the second thermal component 350-2 can provide beneficial compression and structural support during battery pack assembly, enhancing manufacturing efficiency and integration.

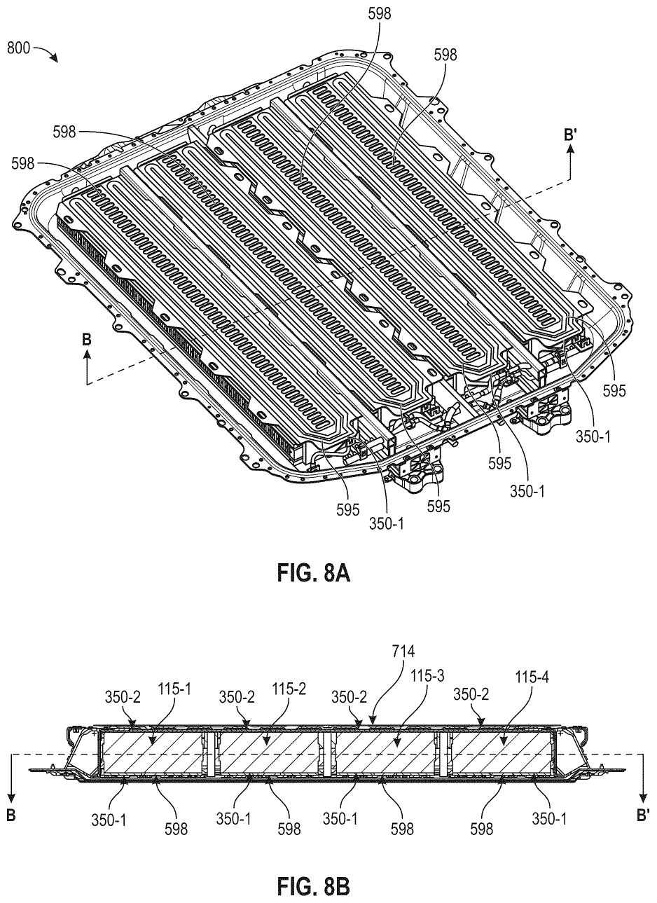

FIG. 8A illustrates a perspective view of a battery pack having multiple modular bottom thermal components, while FIG. 8B illustrates a side view of the battery pack that corresponds to axis B-B′ of FIG. 8B in accordance with one or more implementations. In one or more implementations, FIG. 8A illustrates a thermal component arrangement 800 in which each battery subassembly 115 is supported by an individual bottom thermal component (e.g., first thermal component 350-1). The first thermal component 350-1 may be positioned within the vehicle 100 such that, when installed, the battery pack 110 is located above it, with the top side of the first thermal component 350-1 in contact with the underside of the battery cells 120. The first thermal component 350-1 may function as the primary cooling component, while the second thermal component 350-2 may be an optional component included in high-performance configurations.

In one or more implementations, the thermal component arrangement 800 utilizes parallel flow paths to each battery subassembly 115. The second thermal component 350-2 may employ a direct out-and-back first circulation channel 590, while the first thermal component 350-1 may include a similar out-and-back second circulation channel 595 with a venting architecture 598 having vented sections positioned to avoid routing fluid through certain regions at the bottom of the battery cells 120.

Each of the first thermal component 350-1 may incorporate the venting architecture 598, which includes vents and attachment points, to enable bolting of the first thermal component 350-1 into the vehicle 100 structure, allowing the battery subassembly 115 assembly to function as a structural shear element. This shear capability may be beneficial in safety load cases such as side-impact collisions, including pole-impact events, by contributing to the distribution of loads across the width of the vehicle 100. In some electric vehicle architectures, where the battery pack 110 enclosure occupies significant underbody volume, the integration of the first thermal component 350-1 into the longitudinal structure of the battery pack 110 may enhance its ability to sustain lateral loads. In other implementations where the first thermal component 350-1 is omitted, a separate shear plate or shield plate may be incorporated to maintain structural performance in the absence of the cooling function.

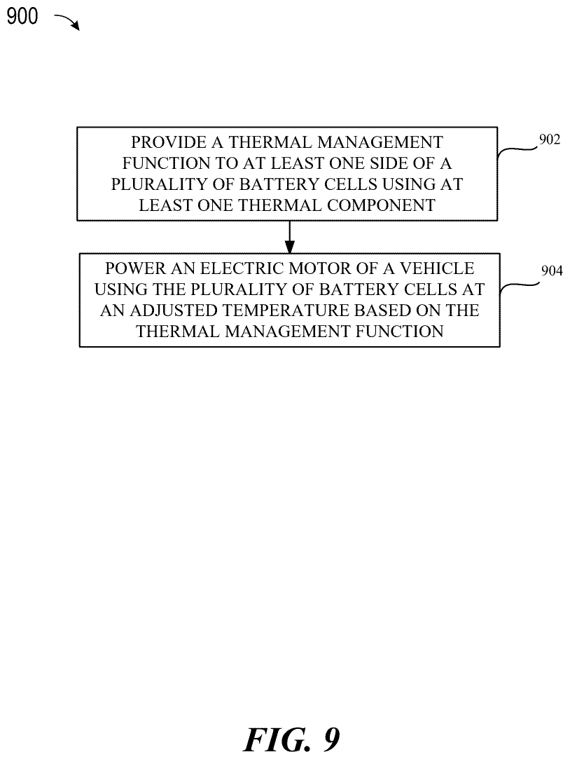

FIG. 9 is a flow chart of illustrative operations that may be performed for thermal regulation of batteries using a single thermal component configuration in accordance with one or more implementations. For explanatory purposes, a process 900 is primarily described herein with reference to the vehicle 100, the thermal system architecture 300, the first thermal component 350-1 of FIGS. 3A, 3B, 4A and 4B, the second thermal component 350-2 of FIGS. 3A and 3B, and the thermal system architecture 400 of FIGS. 4A and 4B. However, the process 900 is not limited to the vehicle 100, the thermal system architecture 300, the first thermal component 350-1 of FIGS. 3A, 3B, 4A and 4B, the second thermal component 350-2 of FIGS. 3A and 3B, and the thermal system architecture 400 of FIGS. 4A and 4B, and one or more blocks (or operations) of the process 900 may be performed by one or more other components of other suitable moveable apparatuses, devices, or systems. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, a thermal management system may a provide thermal management function (e.g., cooling or heating) to at least one side of a plurality of battery cells (e.g., battery cells 120) using at least one thermal component (e.g., the first thermal component 350-1).

At block 904, the thermal management system may facilitate in powering an electric motor of the vehicle 100 using the plurality of battery cells at an adjusted temperature based on the thermal management function.

The thermal management system may provide the thermal management function to a first side of the plurality of battery cells using a first thermal component of a plurality of thermal components. The thermal management system may also provide the thermal management function to a second side of the plurality of battery cells using a second thermal component of the plurality of thermal components. The thermal management system may route fluid through the first thermal component and the second thermal component based on a thermal load condition. The thermal management system may select one of the first thermal component or the second plate based on a thermal load condition. The thermal management system may actuate a valve to control a flow of fluid through the first thermal component and the second thermal component. The thermal management system may route a first fluid through the first thermal component associated with a first thermal loop and routing a second fluid through the second thermal component associated with a second thermal loop separate from the first thermal loop. In one or more implementations, the second fluid is different from the first fluid.

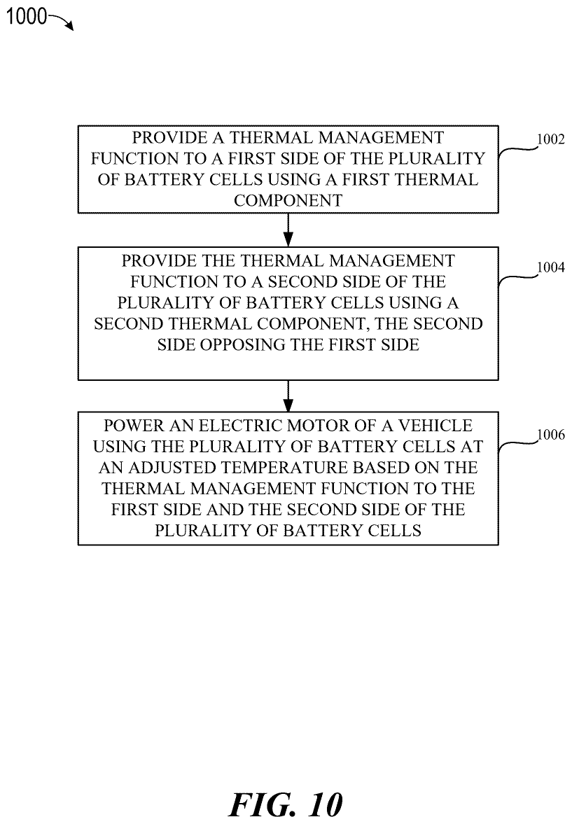

FIG. 10 is a flow chart of illustrative operations that may be performed for thermal regulation of batteries using a dual thermal component configuration in accordance with one or more implementations. For explanatory purposes, a process 1000 is primarily described herein with reference to the vehicle 100, the thermal system architecture 300, the first thermal component 350-1 of FIGS. 3A, 3B, 4A and 4B, the second thermal component 350-2 of FIGS. 3A and 3B, and the thermal system architecture 400 of FIGS. 4A and 4B. However, the process 1000 is not limited to the vehicle 100, the thermal system architecture 300, the first thermal component 350-1 of FIGS. 3A, 3B, 4A and 4B, the second thermal component 350-2 of FIGS. 3A and 3B, and the thermal system architecture 400 of FIGS. 4A and 4B, and one or more blocks (or operations) of the process 1000 may be performed by one or more other components of other suitable moveable apparatuses, devices, or systems. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, providing thermal dissipation from a first side of the plurality of battery cells using a first thermal component of a plurality of thermal components.

As illustrated in FIG. 10, at block 1004, providing thermal dissipation from a second side of the plurality of battery cells using a second thermal component of the plurality of thermal components, the second side opposing the first side.

At block 1006, the thermal management system may facilitate in powering an electric motor of the vehicle 100 using the plurality of battery cells at an adjusted temperature based on the thermal dissipation.

The thermal management system may route fluid through the first thermal component and the second thermal component based on a thermal load condition. The thermal management system may select one of the first thermal component or the second plate based on a thermal load condition. The thermal management system may actuate a valve to control a flow of fluid through the first thermal component and the second thermal component. The thermal management system may route a first fluid through the first thermal component associated with a first thermal loop and routing a second fluid through the second thermal component associated with a second thermal loop separate from the first thermal loop. In one or more implementations, the second fluid is different from the first fluid.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A thermal management system comprising:
at least one thermal component; and
at least one support layer mechanically coupled to the at least one thermal component,
wherein the at least one thermal component is configured to provide a thermal management function to at least one side of a plurality of battery subassemblies.

2. The thermal management system of claim 1, wherein the at least one support layer is arranged between the at least one thermal component and a base plate of a battery pack.

3. The thermal management system of claim 1, wherein the at least one support layer is arranged between the at least one thermal component and a lid of a battery pack.

4. The thermal management system of claim 1, wherein the at least one thermal component is mechanically coupled to a first side of the plurality of battery subassemblies, further comprising a plurality of support layers, wherein a first support layer of the plurality of support layers is arranged between the at least one thermal component and a base plate of a battery pack, and wherein a second support layer of the plurality of support layers is arranged between the plurality of battery subassemblies and a lid of the battery pack, wherein the second support layer is mechanically coupled to a second side of the plurality of battery subassemblies, the second side opposing the first side.

5. The thermal management system of claim 1, further comprising a first support layer and a second support layer, wherein the second support layer has a greater thickness than the first support layer.

6. The thermal management system of claim 1, further comprising a plurality of thermal components, wherein a first thermal component of the plurality of thermal components is mechanically coupled to a first side of the plurality of battery subassemblies, and wherein a second thermal component of the plurality of thermal components is mechanically coupled to a second side of the plurality of battery subassemblies, the second side opposing the first side.

7. The thermal management system of claim 1, further comprising a plurality of thermal components and a plurality of support layers, wherein a first support layer of the plurality of support layers is arranged between a first thermal component of the plurality of thermal components and a base plate of a battery pack, and wherein a second support layer of the plurality of support layers is arranged between a second thermal component of the plurality of thermal components and a lid of the battery pack.

8. The thermal management system of claim 7, wherein the second support layer has a same thickness as the first support layer.

9. The thermal management system of claim 6, wherein the first thermal component is coupled to a support structure of a battery pack and is configured to seal an energy volume of the battery pack, and wherein the second thermal component is not directly coupled to the support structure of the battery pack and is configured as a floating structure.

10. The thermal management system of claim 6, wherein the first thermal component and the second thermal component comprise different flow channel structures.

11. The thermal management system of claim 6, wherein the first thermal component and the second thermal component are configured to be used interchangeably, with one of the first thermal component or the second thermal component being selected based on a thermal load condition.

12. The thermal management system of claim 6, further comprising a valve configured to control a flow of fluid through the first thermal component and the second thermal component.

13. The thermal management system of claim 6, wherein the first thermal component is associated with a first thermal loop and the second thermal component is associated with a second thermal loop, wherein the second thermal loop utilizes a different fluid from the first thermal loop.

14. The thermal management system of claim 1, wherein the thermal management function comprises at least one of cooling or heating.

15. An apparatus, comprising:
a first thermal component configured to provide a thermal management function to a first side of a plurality of battery cells; and
a second thermal component configured to provide the thermal management function to a second side of the plurality of battery cells, the second side opposing the first side,
wherein the thermal management function comprises at least one of cooling or heating,
wherein the first thermal component is coupled to a support structure of a battery pack and is further configured to seal an energy volume of the battery pack, and
wherein the second thermal component is not directly coupled to the support structure of the battery pack and is further configured as a floating structure.

16. The apparatus of claim 15, further comprising:
a lid;
a base plate; and
a plurality of support layers, wherein a first support layer of the plurality of support layers is mechanically coupled to the first thermal component and the base plate, and wherein a second support layer of the plurality of support layers is mechanically coupled to the second thermal component and the lid.

17. The apparatus of claim 15, wherein a fluid is routed through at least one of the first thermal component or the second thermal component based on a thermal load condition.

18. The apparatus of claim 15, further comprising a valve configured to control a flow of fluid through the first thermal component and the second thermal component.

19. The apparatus of claim 15, further comprising a first thermal loop configured to route a first fluid through the first thermal component and a second thermal loop configured to route a second fluid through the second thermal component, wherein the second thermal loop is separate from the first thermal loop, and wherein the second fluid is different from the first fluid.

20. A vehicle, comprising:
a lid;
a base plate;
at least one thermal component configured to provide a thermal management function to at least one side of a plurality of battery subassemblies, wherein the thermal management function comprises at least one of cooling or heating; and
a plurality of support layers, wherein a first support layer of the plurality of support layers is mechanically coupled to the at least one thermal component and the base plate, and wherein a second support layer of the plurality of support layers is arranged between the plurality of battery subassemblies and the lid.
